(19) United States
(12) Patent Application Publication
(10) Pub. No.: US 2012/0030254 A1
(43) Pub. Date: Feb. 2, 2012

(54) INFORMATION PROCESSING DEVICE, INFORMATION DISPLAY METHOD, AND COMPUTER PROGRAM

(75) Inventor: Reiko MIYAZAKI, Tokyo (JP)

(73) Assignee: Sony Corporation, Tokyo (JP)

(21) Appl. No.: 13/154,987

(22) Filed: Jun. 7, 2011

(30) Foreign Application Priority Data
Jul. 27, 2010 (JP) 2010-168337

(51) Int. Cl. G06F 17/30

(52) U.S. Cl. 707/805; 707/E17.03

(57) ABSTRACT

There is provided an information processing device including a search condition display controller configured to visually display search conditions that are adapted to be linked together based on an operation of a user, and to control display positions of the search conditions in response to an operation of the user, and a search processing section configured to change a logical expression of the search conditions in accordance with display states of the search conditions displayed by the search condition display controller, and to execute a search.

### BACKGROUND

The present disclosure relates to an information processing device, an information display method, and a computer program.

Searching for document files, websites on the Internet, image files, or movie files is commonly and widely carried out using a graphical user interface (GUI). That is, there has been widely used a method of entering and selecting a search condition in a textbox or the like, and then holding down a button such as a “search” button to start a search process, or a method of causing a search process to be executed at the point when a search condition is entered in a textbox or the like, and then displaying a list of document files, websites on the Internet, image files, or movie files that match the search condition on the screen (for example, see JP 2010-57057A and WO 2008/093783A).

In the case in which a plurality of search conditions are used to search for files or websites that match the conditions, for example, there has also been widely used a method of performing an AND search or an OR search by explicitly entering a logical operator “AND” or “OR” in a textbox.

For example, when a user attempts to search for websites that match both the keywords: “Tokyo” and “Osaka,” he/she can obtain a list of websites that match the conditions by entering “Tokyo AND Osaka” in the textbox on the browser. Meanwhile, when the user attempts to search for websites that contain either one of “Tokyo” or “Osaka,” for example, he/she can obtain a list of websites that match the conditions by entering “Tokyo OR Osaka” in the textbox on the browser.

### SUMMARY

However, there has been a problem that when files that match the conditions are attempted to be searched for in a state in which a number of thumbnail images such as photo files, movie files, or music files are displayed, it would be difficult to perform an intuitive search by switching between the aforementioned AND condition and OR condition.

In light of the foregoing, it is desirable to provide a novel and improved information processing device, information display method, and computer program that can provide an intuitive search process by allowing the search condition to be easily switched.

According to an embodiment of the present disclosure, there is provided an information processing device including a search condition display controller configured to visually display search conditions that are adapted to be linked together based on an operation of a user, and to control display positions of the search conditions in response to an operation of the user, and a search processing section configured to change a logical expression of the search conditions in accordance with display states of the search conditions displayed by the search condition display controller, and to execute a search.

The search processing section may, when the search conditions displayed by the search condition display controller are linked together, execute an AND search using the search conditions, and when the search conditions displayed by the search condition display controller are not linked together, execute an OR search using the search conditions.

The search conditions visually displayed by the search condition display controller may be circular in shape.

The search condition display controller may, when the search conditions visually displayed by the search condition display controller have come into contact with one another, display the search conditions by integrating the search conditions.

When a second search condition displayed by the search condition display controller has been moved and located in proximity to a first search condition visually displayed by the search condition display controller for a period longer than or equal to a given period, the search condition display controller may display the second search condition inside the first search condition, and the search processing section may execute an AND search using the first search condition and the second search condition.

When, in a state in which the second search condition is displayed inside the first search condition, a third search condition displayed by the search condition display controller has been moved and located in proximity to the first search condition for a period longer than or equal to a given period, the search condition display controller may display the second search condition and the third search condition inside the first search condition, and the search processing section may change the logical expression of the search conditions in accordance with a linkage state of the second search condition and the third search condition, and execute a search.

When a second search condition displayed by the search condition display controller has been moved and located in proximity to a first search condition visually displayed by the search condition display controller, the search condition display controller may control an easiness for the first search condition and the second search condition to be linked together based on a result of an AND search executed using the first search condition and the second search condition.

The search condition display controller may, if the AND search executed using the first search condition and the second search condition has no matching result, perform control such that the first search condition and the second search condition are not linked together.

When a predesignated search condition is specified, the search condition display controller may visually display the specified search condition.

The search processing section may execute a search process in accordance with the display positions of the search conditions displayed by the search condition display controller.

According to another embodiment of the present disclosure, there is provided an information display method including controlling a search condition display by visually displaying search conditions that are adapted to be linked together based on an operation of a user and by controlling display positions of the search conditions in response to an operation of the user, and processing a search by changing a logical expression of the search conditions in accordance with display states of the search conditions and by executing a search.

According to still another embodiment of the present disclosure, there is provided a computer program for causing a computer to execute controlling a search condition display by visually displaying search conditions that are adapted to be linked together based on an operation of a user and by controlling display positions of the search conditions in response to an operation of the user, and processing a search by changing a logical expression of the search conditions in accordance with display states of the search conditions and by executing a search.

According to the embodiments of the present disclosure described above, it is possible to provide a novel and improved information processing device, information display method, and computer program that can provide an intuitive search process by allowing the search condition to be easily switched.

### BRIEF DESCRIPTION OF THE DRAWINGS

FIG. 1 is an explanatory diagram showing the appearance of an information processing device 100 in accordance with one embodiment of the present disclosure;

FIG. 2 is an explanatory diagram showing the function and the configuration of the information processing device 100 in accordance with one embodiment of the present disclosure;

FIG. 3 is an explanatory diagram showing the function and the configuration of a controller 160;

FIG. 4 is an explanatory diagram showing an exemplary screen displayed on a display section 110 of the information processing device 100 in accordance with one embodiment of the present disclosure;

FIG. 5 is an explanatory diagram showing an exemplary screen displayed on the display section 110 of the information processing device 100 in accordance with one embodiment of the present disclosure;

FIG. 6 is an explanatory diagram showing an exemplary screen displayed on the display section 110 of the information processing device 100 in accordance with one embodiment of the present disclosure;

FIG. 7 is an explanatory diagram showing an exemplary screen displayed on the display section 110 of the information processing device 100 in accordance with one embodiment of the present disclosure;

FIG. 8 is a flowchart illustrating the operation of the information processing device 100 in accordance with one embodiment of the present disclosure;

FIG. 9 is an explanatory diagram showing an example in which a search condition is specified with the linkage state of bubbles;

FIG. 10 is an explanatory diagram showing an example in which a search condition is specified with the linkage state of bubbles;

FIG. 11 is an explanatory diagram showing an example in which a search condition is specified with the linkage state of bubbles;

FIG. 12 is an explanatory diagram showing an example in which a search condition is specified with the display state of bubbles;

FIG. 13 is an explanatory diagram showing an example in which two bubbles that have been linked together are separated;

FIG. 14 is an explanatory diagram showing an exemplary screen displayed on the display section 110 when a search process is performed using a character string entered with the use of a character entry function of the information processing device 100;

FIG. 15 is an explanatory diagram showing a state in which a plurality of pieces of information (windows) are displayed on the display section 110; and

FIG. 16 is an explanatory diagram showing a state in which the size of a bubble is changed through an operation of a user of the information processing device 100.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

<1. One Embodiment of the Present Disclosure>

[1-1. Exemplary Appearance of Information Processing Device]

[1-2. Function and Configuration of Information Processing Device]

[1-3. Operation of Information Processing Device]

<2. Conclusion>

### 1. ONE EMBODIMENT OF THE PRESENT DISCLOSURE

### [1-1. Exemplary Appearance of Information Processing Device]

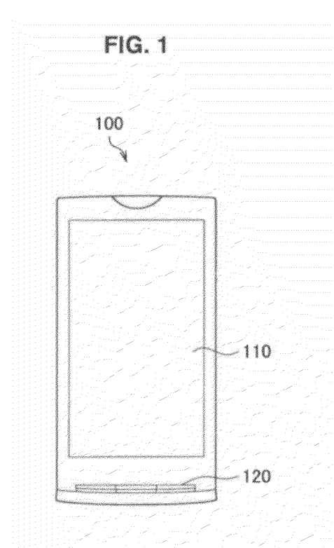

First, an exemplary appearance of an information processing device in accordance with one embodiment of the present disclosure will be described. FIG. 1 is an explanatory diagram showing the appearance of an information processing device 100 in accordance with one embodiment of the present disclosure. Hereinafter, the appearance of the information processing device 100 in accordance with one embodiment of the present disclosure will be described.

As shown in FIG. 1, the information processing device 100 in accordance with one embodiment of the present disclosure is a portable communication terminal and has, in addition to a call function, a function of viewing websites on the Internet, a function of capturing a still image or a moving image, a function of viewing the captured image, a music playback function, a document display function, and the like.

The information processing device 100 has a touch-panel type display section 110 and an operation button section 120. A user can perform various operations (e.g., a call process, a Web site viewing process, a process of capturing a still image or a moving image, a process of viewing the captured image, a music playback process, or a document display process) on the information processing device 100 by touching the display section 110 with a finger or by operating the operation button section 120.

The display section 110 displays various information in accordance with the processing operation of the information processing device 100. Information displayed on the display section 110 can be the following, for example: information on a telephone directory for selecting a party to make a call to or on a party the user is talking to when the call function is executed; websites on the Internet when the website viewing function is executed; a still image or a moving image that is to be captured or has been captured; content of music that is being played when the music playback function is executed; and document data when the document display function is executed.

As described above, the display section 110 has a touch panel, and the user of the information processing device 100 can operate the information processing device 100 by touching the display section 110 with a finger. Touching the display section 110 having a touch panel with a finer allows the following to be performed, for example: selecting a party to make a call to, selecting a website on the Internet, a process of capturing a still image or a moving image, a process of viewing or searching for the captured image, playback or pause of music, and viewing of document data.

In addition, the information processing device 100 in accordance with this embodiment can perform an intuitive search process by easily switching the search condition (i.e., easily switching between an AND condition and an OR condition) when mainly the display section 110 with a touch panel is touched. The details of the search process of the information processing device 100 in accordance with this embodiment are described below.

The operation button section 120 is a button for operating the information processing device 100. The operation of the operation button section 120 differs according to various functions executed by the information processing device 100. The user of the information processing device 100 can operate the information processing device 100 by operating the operation button section 120 or by combining an operation on the display section 110 and an operation on the operation button section 120.

Described above with reference to FIG. 1 is the appearance of the information processing device 100 in accordance with one embodiment of the present disclosure. Next, the function and the configuration of the information processing device 100 in accordance with one embodiment of the present disclosure will be described.

### [1-2. Function and Configuration of Information Processing Device]

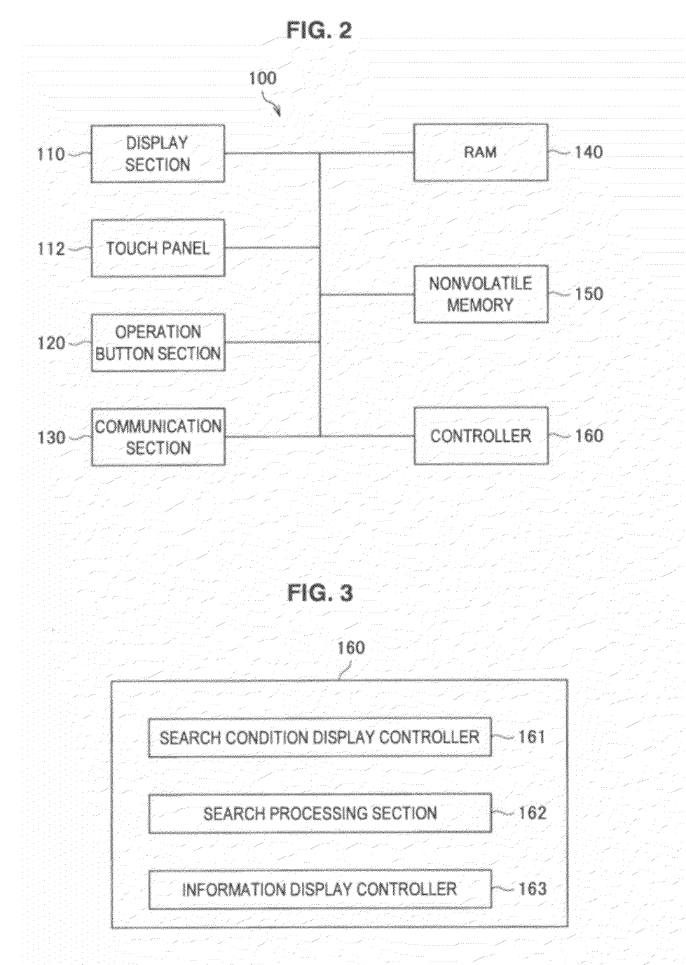

FIG. 2 is an explanatory diagram showing the function and the configuration of the information processing device 100 in accordance with one embodiment of the present disclosure. Hereinafter, the function and the configuration of the information processing device 100 in accordance with one embodiment of the present disclosure will be described with reference to FIG. 2.

As shown in FIG. 2, the information processing device 100 in accordance with one embodiment of the present disclosure includes the display section 110 with a touch panel 112, the operation button section 120, a communication section 130, RAM 140, nonvolatile memory 150, and a controller 160.

The display section 110 displays various information in accordance with various processes (e.g., a call process, a website viewing process, a process of capturing a still image or a moving image, a process of viewing the captured image, a music playback process, and a document display process) of the information processing device 100. Display of the information on the display section 110 is controlled by the controller 160 (described below).

The display section 110 has the touch panel 112. The user of the information processing device 100 can operate the information processing device 100 by touching the display section 110 with a finger. For the touch panel 112, a resistive-film touch panel can be used, for example. A resistive-film touch panel is formed by stacking members such as films, glass, or the like, which are provided with transparent conductive films (ITO; Indium Tin Oxide) as electrodes arranged in a lattice pattern, such that the transparent conductive films are opposite each other with spacers interposed therebetween. When the transparent conducive films are brought into contact with each other due to the surface of the touch panel being pressed with an input object, a change in the current distribution occurs, whereby the pressure can be detected. In addition, the position of the display section 110 that is touched by the input object can be identified based on the electrode position through which current has flowed upon application of the pressure.

As described above, the operation button section 120 is a button for operating the information processing device 100, and the operation of the operation button section 120 differs according to various functions executed by the information processing device 100. The user of the information processing device 100 can operate the information processing device 100 by operating the operation button section 120 or by combining an operation on the display section 110 and an operation on the operation button section 120.

When the user of the information processing device 100 has operated the operation button section 120, the controller 160 (described below) detects the operation on the operation button section 120. Then, the controller 160 executes control in accordance with the process that is being executed by the information processing device 100. As the controller 160 executes such control, the information processing device 100 can execute a process corresponding to the operation of the user on the operation button section 120.

The communication section 130 executes wireless communication between the information processing device 100 and another device. The communication section 130 executes a call process with another portable terminal or a fixed-line phone, a process of accessing a web server, or the like under the control of the controller 160. As the communication section 130 executes wireless communication, the information processing device 100 can exchange sound, information, or the like with another device.

Though not shown, the communication section 130 includes an encoder for encoding data with a predetermined encoding scheme, a decoder for decoding data that has been encoded with the encoding scheme, an antenna for wirelessly transmitting data, and the like.

The RAM 140 is memory for temporarily storing data when the information processing device 100 executes various processes. The nonvolatile memory 150 is memory, information in which will not disappear even after the information processing device 100 is turned off. The nonvolatile memory 150 can store various settings information on the information processing device 100, information such as image data or music data stored by the information processing device 100, computer programs for operating the information processing device 100, and the like. The computer programs stored in the nonvolatile memory 150 are sequentially read by the controller 160 (described below) and are executed by the controller 160.

The controller 160 controls the operation of the information processing device 100. The controller 160 can control the operation of the information processing device 100 by sequentially reading the computer programs stored in the nonvolatile memory 150 and executing them, for example.

Control of the operation of the information processing device 100 by the controller 160 will be exemplarily described. When the user of the information processing device 100 has operated the operation button section 120, the controller 160 detects the operation of the user on the operation button section 120. Then, the controller 160 performs adequate control (e.g., calling a party to talk to, acquisition of a webpage, or playback of a music file) in accordance with the process that is being executed by the information processing device 100.

In addition, when the user of the information processing device 100 has touched the display section 110 with a finger, the position of the touch and the type of the operation of the user are detected with the touch panel 112. Then, the controller 160 performs adequate control (e.g., selecting a party to make a call to, selecting a website, selecting a music file to be played, or specifying a search condition when searching for an image file) in accordance with the position of the touch of the user, the type of the operation of the user, and the process that is being executed by the information processing device 100.

As described above, the controller 160 can control the operation of the information processing device 100 in accordance with the operation of the user.

Described above with reference to FIG. 2 are the function and the configuration of the information processing device 100 in accordance with one embodiment of the present disclosure. Next, the function and the configuration of the controller 160 shown in FIG. 2 will be described in detail.

FIG. 3 is an explanatory diagram showing the function and the configuration of the controller 160 shown in FIG. 2. Hereinafter, the function and the configuration of the controller 160 will be described in detail with reference to FIG. 3.

As shown in FIG. 3, the controller 160 includes a search condition display controller 161, a search processing section 162, and an information display controller 163.

The search condition display controller 161 displays, when the information processing device 100 executes a search process, information that represents a search condition on the display section 110. When the information processing device 100 executes a search process, a search condition is specified by the user. The search condition display controller 161 displays information that represents the search condition specified by the user on the display section 110.

The information processing device 100 in accordance with this embodiment is characterized by displaying a search condition in the shape of a circle on the display section 110 so that the visibility of the search condition is increased. In addition, the information processing device 100 in accordance with this embodiment is characterized by being capable of easily switching the search condition (an AND condition and an OR condition) by integrating a plurality of search conditions that are displayed in the shape of circles on the display section 110 by moving them into proximity to one another, or by separating the plurality of search conditions that have been integrated. Note that in the following description, a search condition with such a circular shape shall also be referred to as a “bubble.”

The search processing section 162 executes a predetermined search process using a search condition displayed by the search condition display controller 161. The predetermined search process executed by the search processing section 162 is a process of searching for data that matches the search condition from among the data stored in the nonvolatile memory 150 of the information processing device 100, and is, for example, a process of searching for websites that match the search condition. It is needless to mention that the search process executed by the search processing section 162 is not limited to the examples herein.

When a search target is stored in the information processing device 100, the data search process is executed by the search processing section 162, whereas when a search target (e.g., website) is not stored in the information processing device 100, the actual search process is not executed by the search processing section 162 but is executed by a server of a search site. In such a case, the search processing section 162 does not execute a search for a website, but executes a process of passing a search condition to a search site. In this embodiment, such a search process executed by an external server shall also be described as a search process executed by the search processing section 162.

The information display controller 163 controls display of information on the display section 110 and, for example, controls display of the results of a search process executed by the search processing section 162 on the display section 110. When a search condition has been specified by the user of the information processing device 100 and the search processing section 162 has executed a search process using the search condition and thus has obtained search results, the information display controller 163 displays the search results obtained by the search processing section 162 on the display section 110.

With the aforementioned configuration of the controller 160, the information processing device 100 in accordance with this embodiment can display bubbles, which represent search conditions, on the display section 110 and execute a search process by adequately switching the search condition in accordance with the linkage state of the bubbles.

Described above with reference to FIG. 3 are the function and the configuration of the controller 160. Next, the operation of the information processing device 100 in accordance with one embodiment of the present disclosure will be described.

### [1-3. Operation of Information Processing Device]

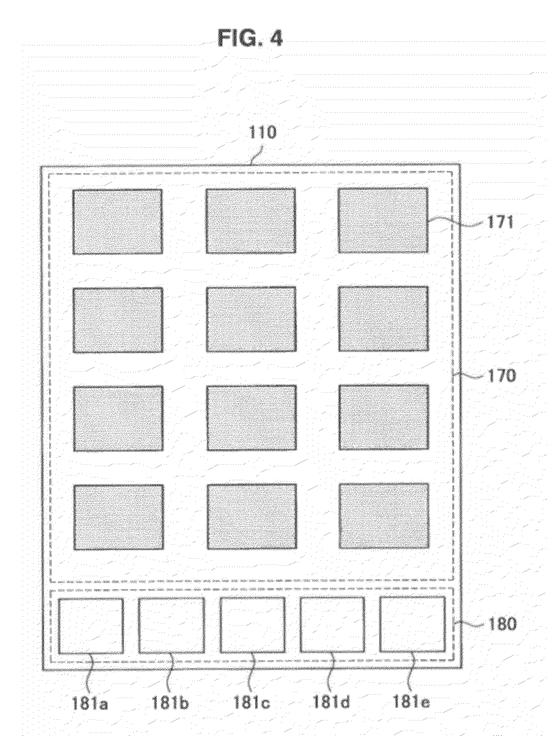

The operation of the information processing device 100 in accordance with one embodiment of the present disclosure will be described with reference to specific examples. FIGS. 4 to 7 are explanatory diagrams each showing an exemplary screen displayed on the display section 110 of the information processing device 100 in accordance with one embodiment of the present disclosure.

FIG. 4 shows an exemplary screen, which is displayed on the display section 110, for searching for image data stored in the information processing device 100. Note that in FIG. 4 and the like, dashed lines on the display section 110 are shown for the convenience of the description, and thus the dashed lines need not be displayed on the display section 110.

FIG. 4 shows a state in which an image data display region 170 and a search condition display region 180 are displayed on the display section 110 under the control of the information display controller 163. As shown in FIG. 4, image data 171 is displayed as thumbnails in the image data display region 170. Although the image data 171 is the image data stored in the information processing device 100 in this embodiment, it is needless to mention that image data to be searched for in the present disclosure is not limited to the image data stored in the information processing device 100.

In addition, as shown in FIG. 4, search condition display portions 181a, 181b, 181c, 181d, and 181e are displayed in the search condition display region 180. The search condition display portions 181a to 181e represent conditions for searching for image data stored in the information processing device 100. Various conditions can be specified as the search conditions. For example, an image of an adult male, an image of an adult female, an image of a boy, an image of a girl, an image of an animal, an image of scenery, and the like can be specified as the search conditions. The user of the information processing device 100 can find out the desired image data from among the image data stored in the information processing device 100 by selecting any of the search condition display portions 181a to 181e displayed in the search condition display region 180.

In this embodiment, the user of the information processing device 100 can touch the search condition display portions 181a to 181e displayed on the display section 110 with a finger. The search condition display controller 161 can detect a touch of the user of the information processing device 100 on the search condition display portions 181a to 181e.

The search condition display controller 161, upon detecting a touch of the user of the information processing device 100 on one of the search condition display portions 181a to 181e, creates a “bubble” corresponding to the search condition selected by the user, and displays the bubble on the display section 110. The bubble displayed on the display section 110 can be moved on the screen by being touched by the user of the information processing device 100. When the bubble has been moved to the image data display region 170, the search processing section 162 starts a search process using the search condition corresponding to the bubble.

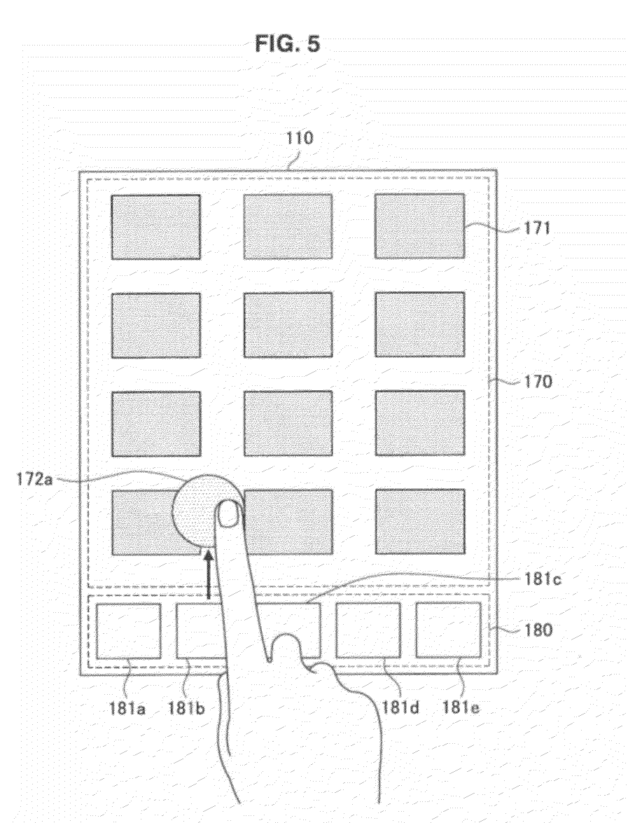

FIG. 5 shows an exemplary state in which a bubble is displayed on the display section 110 by the search condition display controller 161. Specifically, FIG. 5 shows a state in which the search condition display portion 181b has been selected by the user of the information processing device 100, and the search condition display controller 161 displays a bubble 172a corresponding to the search condition display portion 181b on the display section 110.

For example, when a search condition corresponding to the search condition display portion 181b specified by the user of the information processing device 100 is an “image of an adult female” and the bubble 172a corresponding to the search condition display portion 181b has been moved to the image data display region 170, the search processing section 162 starts a process of searching for an “image of an adult female” that is the search condition corresponding to the bubble 172a. Then, when the search processing section 162 has retrieved an “image of an adult female,” the information display controller 163 displays the search results of the “image of an adult female” obtained by the search processing section 162 on the display section 110.

Note that conditions for the start timing of a search process with the search processing section 162 can be set to a point when a bubble has moved to the image data display region 170 as in this embodiment. Alternatively, a search need not be started automatically at the point when a bubble has moved to the image data display region 170, but can be started at the point when the user of the information processing device 100 has operated a button, an icon, or the like for starting a search.

In this embodiment, a search process with the search processing section 162 can be performed using a plurality of bubbles. In addition, the search processing section 162 can execute a search process by switching the search condition in accordance with the linkage state of the plurality of bubbles.

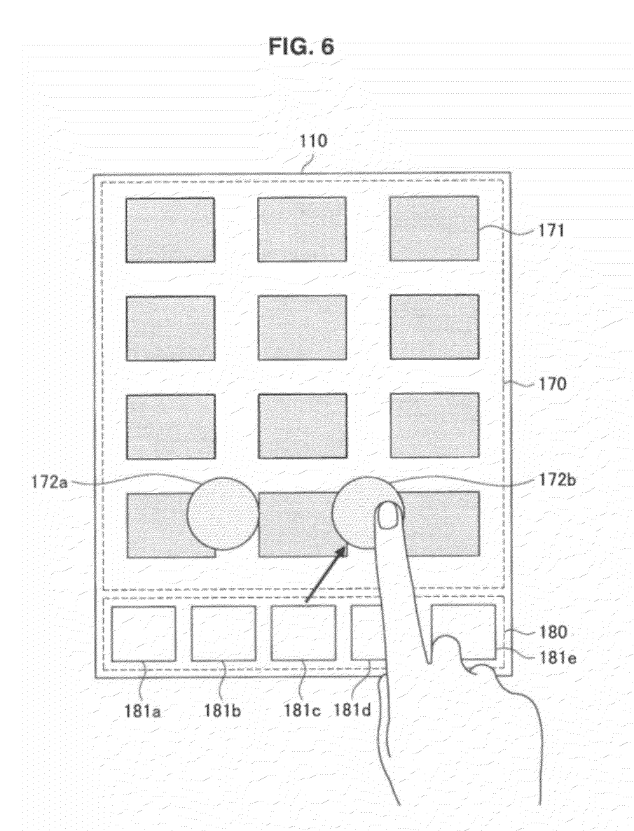

FIG. 6 shows an exemplary state in which bubbles are displayed on the display section 110 by the search condition display controller 161. Specifically, FIG. 6 shows a state in which another bubble 172b is displayed on the display section 110 by the user of the information processing device 100 in the state in which the bubble 172a is already displayed on the display section 110 as shown in FIG. 5. That is, FIG. 6 shows a state in which the search condition display section 181c has been selected through an operation of the user of the information processing device 100, and the search condition display controller 161 displays the bubble 172b corresponding to the search condition display portion 181c on the display section 110.

When another bubble 172b is displayed on the display section 110 as shown in FIG. 6 and the user of the information processing device 100 has moved the bubble 172b to the image data display region 170, the search processing section 162 executes an OR search using the search conditions corresponding to the bubbles 172a and 172b. For example, when the search condition corresponding to the search condition display portion 181b is an “image of an adult female” and the search condition corresponding to the search condition display section 181c is an “image of a boy,” the search processing section 162 starts a process of searching for an “image of an adult female” or an “image of a boy.” Then, when the search processing section 162 has retrieved an “image for an adult female” or an “image of a boy,” the information display controller 163 displays the search results of the “image of an adult female” or the “image of a boy” obtained by the search processing section 162 on the display section 110.

The bubbles 172a and 172b displayed on the display section 110 can be linked together through an operation of the user of the information processing device 100. The search condition display controller 161, upon detecting that the positions of the bubbles 172a and 172b displayed on the display section 110 have been changed through an operation of the user, changes the positions of the bubbles 172a and 172b based on the operation of the user. Then, when the distance between the centers of the bubbles 172a and 172b has become less than or equal to a predetermined distance, the search condition display controller 161 links the bubbles 172a and 172b together and displays the linked bubbles on the display section 110.

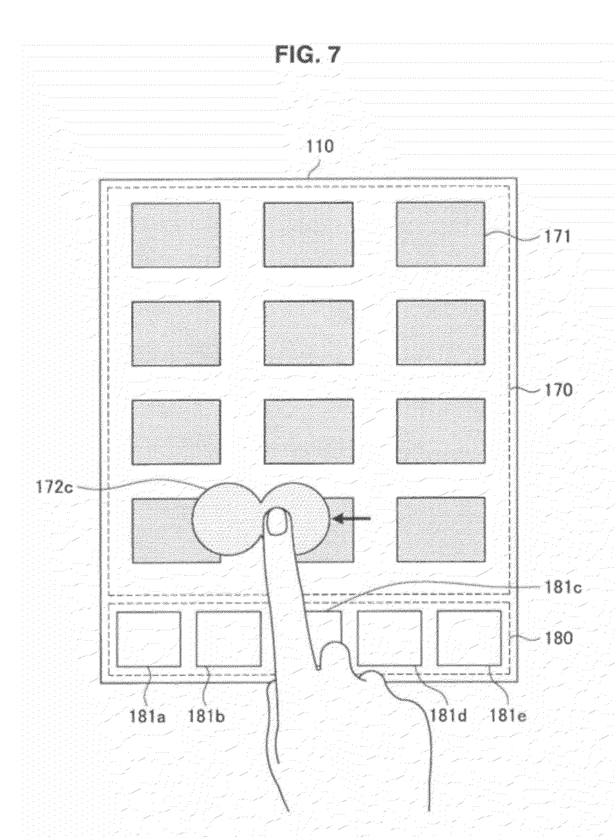

FIG. 7 shows an exemplary state in which bubbles are displayed on the display section 110 by the search condition display controller 161. Specifically, FIG. 7 shows a state in which the two bubbles 172a and 172b are linked together to generate a single bubble 172c through an operation of the user of the information processing device 100 as shown in FIG. 6. That is, a state is shown in which the single bubble 172c is generated by moving the bubble 172b closer to the bubble 172a and thereby linking the two bubbles together.

Note that the bubble 172a and the bubble 172b can also be linked together automatically by the search condition display controller 161 at the point when the bubble 172a and the bubble 172b have come into contact with each other. Alternatively, the bubble 172a and the bubble 172b can be linked together automatically by the search condition display controller 161 not at the point when the bubble 172a and the bubble 172b have come into contact with each other, but at the point when the distance between the centers of the two bubbles has become less than or equal to a predetermined distance.

When the two bubbles 172a and 172b have been linked together to generate a single bubble 172c as described above, the search processing section 162 executes an AND search using the search conditions corresponding to the bubbles 172a and 172b. For example, when the search condition corresponding to the search condition display portion 181b is an “image of an adult female” and the search condition corresponding to the search condition display portion 181c is an “image of a boy,” the search processing section 162 starts a process of searching for an “image of an adult female” and an “image of a boy.” Then, when the search processing section 162 has retrieved an “image of an adult female” and an “image of a boy,” the information display controller 163 displays the search results of the “image of an adult female” and the “image of a boy” obtained by the search processing section 162 on the display section 110.

As described above, as the search processing section 162 executes a search process by switching the search condition between an AND condition and an OR condition in accordance with the linkage state of a plurality of bubbles, the information processing device 100 in accordance with this embodiment can provide an intuitive search operation to the user.

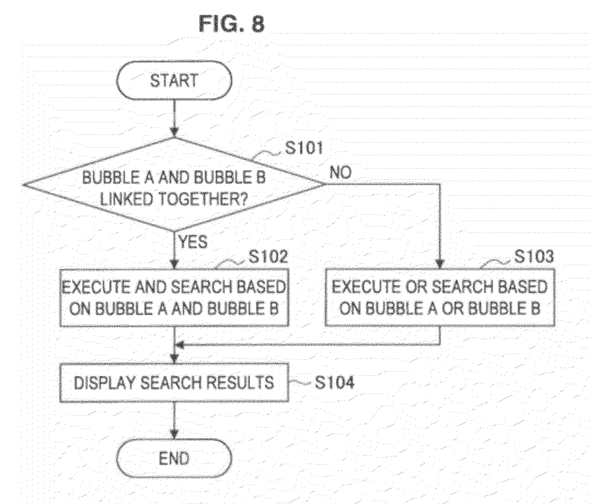

FIG. 8 is a flowchart illustrating the operation of the information processing device 100 in accordance with one embodiment of the present disclosure. FIG. 8 shows the operation of the information processing device 100 when a process of searching for image data is executed using two bubbles. Hereinafter, the operation of the information processing device 100 in accordance with one embodiment of the present disclosure will be described with reference to FIG. 8.

In a state in which the search condition display controller 161 is displaying two bubbles (a bubble A and a bubble B) on the display section 110, the search processing section 162 determines if the two bubbles A and B are linked together (step S101).

If the search processing section 162 has determined that the two bubbles A and B are linked together as a result of the determination in step S101 above, the search processing section 162 executes an AND search using the search conditions corresponding to the two bubbles A and B (step S102).

Meanwhile, if the search processing section 162 has determined that the two bubbles A and B are not linked together as a result of the determination in step S101 above, the search processing section 162 executes an OR search using the search conditions corresponding to the two bubbles A and B (step S 103).

When the search processing section 162 has executed an AND search or an OR search using the search conditions corresponding to the two bubbles A and B in step S102 or step S103 above, the information display controller 163 displays the search results obtained by the search processing section 162 on the display section 110 (step S104).

Provided that the search condition corresponding to the bubble A is an “image of an adult female” and the search condition corresponding to the bubble B is an “image of a boy” and an AND search is attempted to be performed as described above, the search processing section 162 starts a process of searching for an “image of an adult female” and an “image of a boy.” Then, when the search processing section 162 has retrieved an “image of an adult female” and an “image of a boy,” the information display controller 163 displays the search results of the “image of an adult female” and the “image of a boy” obtained by the search processing section 162 on the display section 110.

Meanwhile, in the case of performing an OR search, the search processing section 162 starts a process of searching for an “image of an adult female” or an “image of a boy.” Then, when the search processing section 162 has retrieved an “image of an adult female” or an “image of a boy,” the information display controller 163 displays the search results of the “image of an adult female” or the “image of a boy” obtained by the search processing section 162 on the display section 110.

As described above, as the search processing section 162 executes a search process by switching between an AND condition and an OR condition in accordance with the linkage state of a plurality of bubbles, the information processing device 100 in accordance with this embodiment can provide an intuitive search operation to the user.

In addition, as the search processing section 162 executes a search process by switching the search condition between an AND condition and an OR condition based on the linkage state of bubbles, the user of the information processing device 100 is able to visually understand what kind of search process is being performed.

As the search condition can be switched with the linkage state of bubbles, the information processing device 100 in accordance with this embodiment can execute a search for data or information by easily specifying various search conditions.

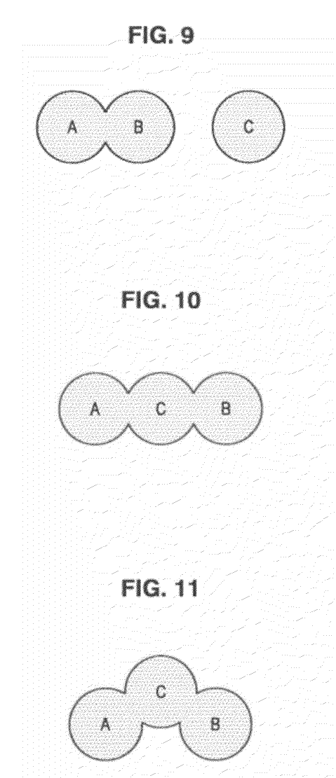

FIG. 9 is an explanatory diagram showing an example in which a search condition is specified with the linkage state of bubbles. FIG. 9 shows only the linkage state of bubbles displayed on the display section 110 for the convenience of the description. Specifically, FIG. 9 shows a state in which, among three bubbles A, B, and C, the bubble A and the bubble B are linked together, and the bubble C is not linked to any other bubble.

As described above, in the state in which, among the three bubbles A, B, and C, the bubble A and the bubble B are linked together, and the bubble C is not linked to any other bubble, the search processing section 162 executes a search based on the condition: “(bubble A AND bubble B) OR bubble C.” The information processing device 100 in accordance with this embodiment can represent such a complex search condition with the linkage state of the bubbles.

FIG. 10 is an explanatory diagram showing another example in which a search condition is specified with the linkage state of bubbles. FIG. 10 also shows only the linkage state of bubbles displayed on the display section 110 for the convenience of the description. Specifically, FIG. 10 shows a state in which the bubble A and the bubble B are linearly linked together, sandwiching therebetween the bubble C at the center.

In the state in which the three bubbles A, B, and C are linked together as described above, the search processing section 162 executes a search based on the condition: “bubble A AND bubble B AND bubble C.”

Although the example shown in FIG. 10 shows a state in which the three bubbles A, B, and C are linearly linked together, the search processing section 162 can, in a state in which the three bubbles are linked together at a predetermined angle, execute a search based on a different search condition.

FIG. 11 is an explanatory diagram showing still another example in which a search condition is specified with the linkage state of bubbles. FIG. 11 also shows only the linkage state of bubbles displayed on the display section 110 for the convenience of the description. Specifically, FIG. 11 shows a state in which the bubble A and the bubble B are linked together not linearly as shown in FIG. 10 but at a predetermined angle, sandwiching therebetween the bubble C at the center.

In the state in which the bubble A and the bubble B are linked together at a predetermined angle, sandwiching therebetween the bubble C at the center as described above, the search processing section 162 executes a search based on the condition: “bubble C AND (bubble A OR bubble B).” The information processing device 100 in accordance with this embodiment can, by linking the bubbles together in this manner, easily specify a complex condition including the condition corresponding to the bubble C and also including either one of the condition corresponding to the bubble A or the condition corresponding to the bubble B.

Note that specifying a search condition using bubbles is not limited to the case in which a plurality of bubbles are linked together. For example, a search condition can be specified by enlarging a single bubble and putting (an)other bubble(s) into the enlarged bubble.

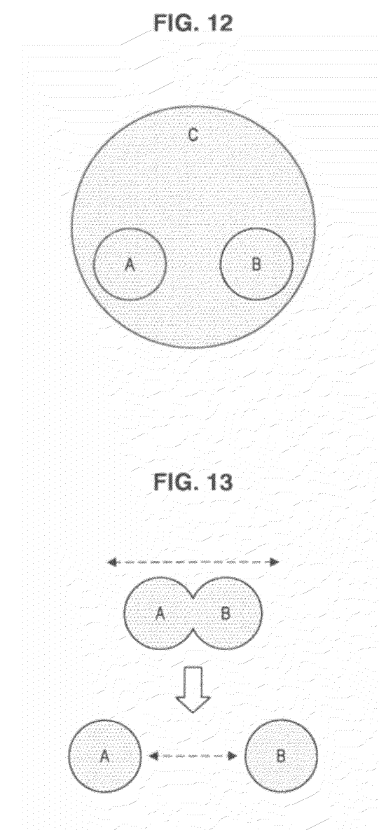

FIG. 12 is an explanatory diagram showing an example in which a search condition is specified with the display state of bubbles. FIG. 12 shows only the state of bubbles displayed on the display section 110 for the convenience of the description. Specifically, FIG. 12 shows a case in which a search condition is specified by enlarging a single bubble (a bubble C) and putting other bubbles (a bubble A and a bubble B) into the enlarged bubble.

In the state in which the bubble A and the bubble B are put into the bubble C in this manner, the search processing section 162 executes a search based on the condition: “bubble C AND (bubble A OR bubble B)” as in the case shown in FIG. 11. The information processing device 100 in accordance with this embodiment can, by putting (an)other bubble(s) into a single bubble in this manner, specify a complex condition including the condition corresponding to the bubble C and also including either one of the condition corresponding to the bubble A or the condition corresponding to the bubble B.

The size of the displayed bubble can be increased by the search condition display controller 161 by being triggered by an operation of the user of the information processing device 100. For example, the search condition display controller 161 can, upon detecting that the bubble displayed on the display section 110 is touched by the user of information processing device 100 with a finger such that the bubble is widened, increase the size of the bubble in response to the detection. Alternatively, the search condition display controller 161 can increase the size of the bubble upon detecting that, in a state in which another bubble has moved closer to the bubble to leave a distance less than a predetermined distance therebetween, such a state has been kept for a period longer than or equal to a predetermined period. As a further alternative, for example, the search condition display controller 161 can, when two bubbles are concurrently moved closer to each other, increase the size of another bubble upon detecting that the two bubbles have moved closer to each other to leave a distance less than a predetermined distance therebetween.

Described above are the exemplary operations of the information processing device 100 when a search process is executed by changing the search condition in accordance with the linkage state or display state of bubbles. Although the aforementioned examples have illustrated exemplary operations of the information processing device 100 when the number of bubbles is two or three, the number of bubbles is not limited thereto. Even when the number of bubbles is four or more, a search process can be similarly executed by changing the search condition in accordance with the difference in the linkage state or display state of the bubbles.

Next, an exemplary operation for separating bubbles, which have been once linked together, will be described. Two bubbles that have been once linked together can be separated by, for example, being touched by the user of the information processing device 100 with a finger or the like and shaken horizontally. FIG. 13 is an explanatory diagram showing an example in which two bubbles that have been linked together are separated. FIG. 13 also shows only the state of the bubbles displayed on the display section 110 for the convenience of the description.

FIG. 13 shows a state in which, when two bubbles A and B are linked together, the two linked bubbles A and B are separated by being touched by the user of the information processing device 100 with a finger or the like and shaken horizontally. Through the operation of shaking the linked bubbles in this manner, the linked bubbles can be separated.

Alternatively, in order to separate the bubbles that have been once linked together, an operation of moving the linked bubbles apart from each other with two fingers can be performed, for example.

As described above, bubbles that have been once linked together can be separated. Separating the linked bubbles allows the search condition to be switched from an AND condition to an OR condition.

Described above is a case in which, when predesignated conditions are specified, the specified search conditions are displayed as bubbles, and the search condition is changed in accordance with the linkage state or display state of the bubbles. However, it is needless to mention that the search conditions of the present disclosure are not limited to the predesignated conditions. For example, even when the information processing device 100 has a character entry function of a keyboard (hard keys or a software keyboard) and a search process is executed using a character string entered with the use of the character entry function, it is also possible to specify a search condition using bubbles as described above.

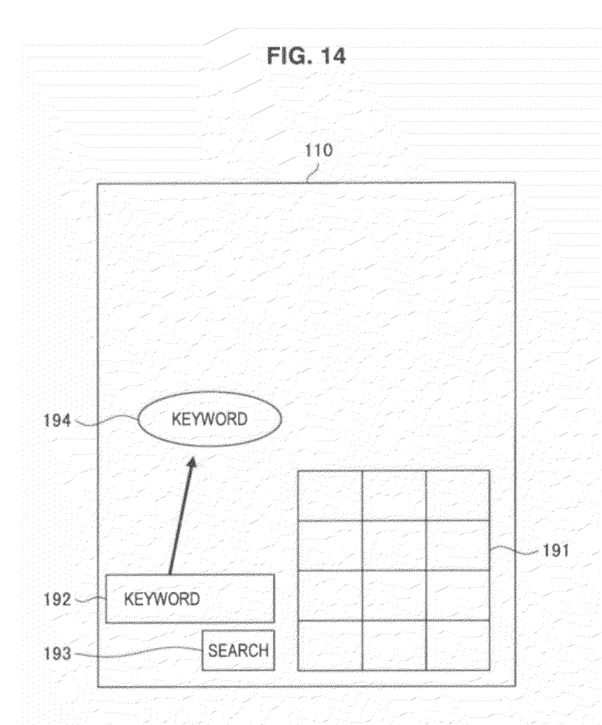

FIG. 14 is an explanatory diagram showing an exemplary screen displayed on the display section 110 when a search process is performed using a character string entered with the use of the character entry function of the information processing device 100. FIG. 14 shows a state in which a software keyboard 191, a textbox 192, and a search button 193 are displayed on the display section 110. Display of such components on the display section 110 is controlled by the information display controller 163.

When the user of the information processing device 100 has entered a search condition by operating the software keyboard 191 displayed on the display section 110 by touching it with a finger, the entered information is displayed in the textbox 192. Then, when the user of the information processing device 100 has touched the search button 193 displayed on the display section 110 with a finger, the search condition display controller 161 displays the information, which is displayed in the textbox 192, on the display section 110 as a bubble 194.

The user of the information processing device 100 can operate the bubble 194, which is displayed on the display section 110 by the search condition display controller 161, with a finger. It is needless to mention that the number of the created bubbles can be more than one. The search processing section 162 can execute a search process based on a search condition corresponding to the bubble or the linkage state of bubbles as described above.

Note that a search process using a bubble such as the one described above can be executed by, when a plurality of pieces of information (windows) are displayed on the display section 110, changing a search key with the search processing section 162 in accordance with the window on which the bubble is located.

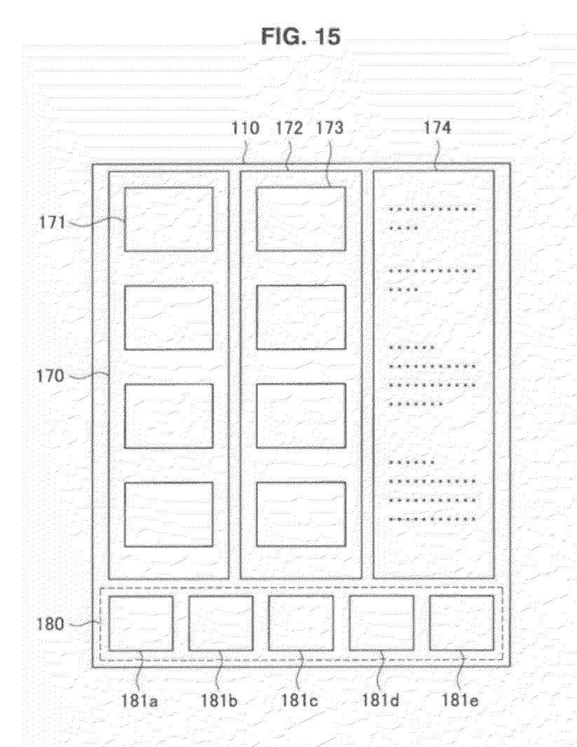

FIG. 15 is an explanatory diagram showing a state in which a plurality of pieces of information (windows) are displayed on the display section 110. In FIG. 15, an image data display region 170, a music data display region 172, and a website display region 174 are displayed as windows on the display section 110. In the image data display region 170, image data 171 is displayed as thumbnails. In the music data display region 172, music data 173 is displayed as thumbnails. In the website display region 174, content of websites is displayed.

In such a state, when the user of the information processing device 100 has touched any of the search condition display portions 181a to 181e, the search condition display controller 161 creates a “bubble” corresponding to the search condition selected by the user. When the user of the information processing device 100 has moved the bubble by touching the display section 110, a search process with the search processing section 162 is executed. The search processing section 162 can execute a search process by changing a search key according to which window the bubble has been moved to.

For example, when the user of the information processing device 100 has moved the bubble to the image data display region 170, the search processing section 162 executes a process of searching for an image that contains the search condition corresponding to the bubble (e.g., an image containing a male, an image containing a female, an image containing a child, or an image containing an animal).

Alternatively, for example, when the user of the information processing device 100 has moved the bubble to the music data display region 172, the search processing section 162 executes a process of searching for music that contains the search condition corresponding to the bubble.

As a further alternative, for example, when the user of the information processing device 100 has moved the bubble to the website display region 174, the search processing section 162 executes a process of searching for a webpage that contains the search condition corresponding to the bubble (e.g., a process of searching for a page that contains description of the search condition corresponding to the bubble, or a process of searching for writing of a particular person).

As described above, the search processing section 162 can execute an adequate search process by changing a search key according to on which position of the display section 110 the bubble is located.

Described above is the operation of the information processing device 100 in accordance with one embodiment of the present disclosure. By executing a search process using a bubble as an object as described above, the information processing device 100 in accordance with one embodiment of the present disclosure can perform various search processes through simple operations and can visually present the search processes to the user.

The search processing section 162 can, before the user explicitly specifies a search condition, execute a search process using a predesignated search condition (e.g., search conditions corresponding to the search condition display portions 181a to 181e displayed in the search condition display region 180) in the background. If such a search process is executed in advance in the background, the information display controller 163 can, when the user of the information processing device 100 attempts to execute a search using bubbles, promptly display the search results of the search processing section 162 on the screen.

If a search process is executed in advance in the background, the search condition display controller 161 can, when an AND search is attempted to be executed using bubbles, for example, execute display control of whether to make it easier for the bubbles to be linked together. That is, when search results can be obtained through an AND search, the search condition display controller 161 controls the display such that bubbles are easily linked together, and when search results cannot be obtained through an AND search, the search condition display controller 161 controls the display such that bubbles are not easily linked together.

It is also possible to give some meaning to the size of bubbles displayed by the search condition display controller 161. For example, the search condition display controller 161 can control the size of bubbles by enlarging or shrinking them according to the number of hits that match the search conditions. When some meaning is given to the size of bubbles in this manner, it becomes possible to visually present the search results to the user of the information processing device 100 by using the bubbles not as the mere search conditions but as assistance for displaying the search results.

In addition, the search condition display controller 161 can control the display of bubbles according to the search results. For example, the search condition display controller 161 can change the color or density of the bubbles according to the number of hits that match the search conditions or the degree of correlation between the search conditions, or can perform display control by illuminating the bubbles.

When a search target has a hierarchical structure like a folder, the information display controller 163 can display the number of hits that match the conditions as a result of a search process. Alternatively, when a search target has a hierarchical structure like a folder, the information display controller 163 can display a folder containing data that match the search conditions using a predetermined effect (e.g., a bubbling effect).

The information display controller 163 can, when displaying the search results of the search processing section 162 on the display section 110, sort the data according to a predetermined condition, or can display the search results by hiding data that does not match the conditions. When the data is sorted according to a predetermined condition, some meaning can be provided to bubbles displayed on the display section 110 by displaying, among the bubbles displayed on the display section 110, bubbles, which represent conditions whose results are to be sorted, in a different way from the other bubbles.

In addition, the information display controller 163, when displaying the search results of the search processing section 162 on the display section 110, controls the display such that the results that do not match the search conditions are not displayed on the display section 110. In such a case, the information display controller 163 can display the results that match the search conditions by filling the place in which the results that do not match the search conditions had been displayed. Alternatively, the information display controller 163 can display the results that match the search conditions without filling the place in which the results that do not match the search conditions had been displayed.

The search condition display controller 161 can also create another bubble as a new search condition from the search results of the search processing section 162. For example, when the search processing section 162 has executed a process of searching for a webpage, the search results are displayed on the display section 110. In such a case, when text that is displayed as the search results is selected through an operation of the user, the search condition display controller 161 can create the text as a new bubble. Herein, the operation of the user for creating the text as a new bubble can be, for example, an operation of holding down the selected portion for a period longer than or equal to a given period, or an operation of dragging the selected portion.

By creating a new search condition from the search results as described above, the information processing device 100 in accordance with an embodiment of the present disclosure can realize a smooth search process with simple operations.

The information display controller 163 can also control the display of the search results of the search processing section 162 based on the relative positional relationship of the bubbles displayed by the search condition display controller 161 on the display section 110. For example, in a state in which two bubbles A and B are displayed on the display section 110 and the two bubbles are not linked together, the search processing section 162 executes an OR search using the search conditions corresponding to the bubbles A and B. In such a case, if the bubble A is located at a relatively upper position than the bubble B, the information display controller 163 can control the display by prioritizing the search condition corresponding to the bubble A.

When the number of bubbles on the display section 110 increases, the visibility of data in the background could decrease. Thus, when the user of the information processing device 100 is not attempting to execute a search process (e.g., when the user is not touching the search condition display region 180), the search condition display controller 161 can reduce the size of the bubbles or lighten the color of the bubbles, whereby it becomes possible to suppress influence on the visibility of data in the background of the bubbles displayed on the display section 110.

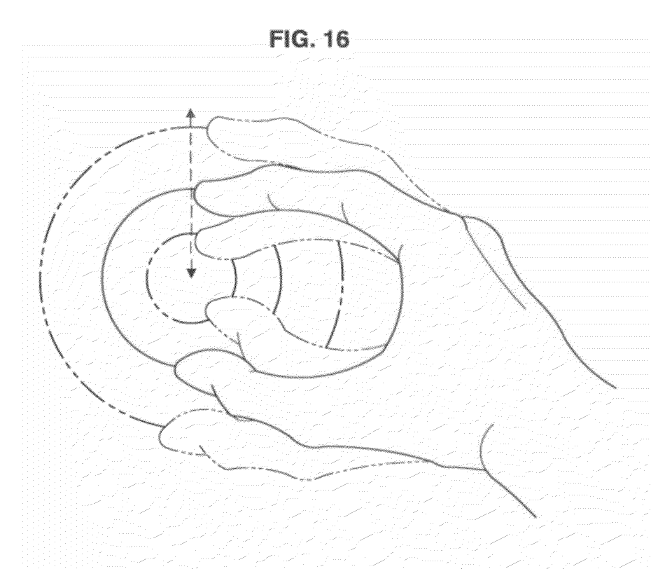

In addition, the size of bubbles displayed on the display section 110 can be changed through an operation of the user of the information processing device 100. FIG. 16 is an explanatory diagram showing a state in which the size of a bubble is changed through an operation of the user of the information processing device 100. A bubble displayed on the display section 110 can be enlarged or shrunk when the display section 110 is touched with two fingers as shown in FIG. 16. As the size of the bubble can be freely changed, it is possible to suppress influence on the visibility of data in the background of the bubble displayed on the display section 110.

A bubble displayed on the display section 110 can be erased through an operation of the user. For example, a bubble displayed on the display section 110 can be erased from the display section 110 through an operation of throwing the bubble out of the display section 110. Alternatively, the bubble can be erased from the display section 110 through an operation of squashing the bubble at the frame of the screen. As a further alternative, the bubble can be erased from the display section 110 by returning the bubble to the initial position (e.g., the search condition display region 180).

### 2. CONCLUSION

According to the information processing device 100 in accordance with one embodiment of the present disclosure described above, when a search process is executed, predetermined objects (bubbles in the aforementioned description) corresponding to search conditions are displayed so that the search process is executed with the objects.

The information processing device 100 in accordance with one embodiment of the present disclosure switches between an AND search and an OR search using the search conditions corresponding to the objects, depending on whether or not the objects are linked together. By visually switching the search condition in this manner, the information processing device 100 in accordance with one embodiment of the present disclosure can provide an intuitive search process to the user and can easily execute a search using a complex condition through simple operations without the need for entry of a complex search formula.

By displaying the search conditions in the form of objects and executing a search process, the information processing device 100 in accordance with one embodiment of the present disclosure can perform various processes according to the linkage state of the objects or the displayed information.

Although the aforementioned description has illustrated circular bubbles as an example of the search conditions to be displayed visually, it is needless to mention that the search conditions to be displayed visually in accordance with the present disclosure are not limited thereto. For example, it is also possible to display search conditions in the shape of hexagons as the search conditions to be displayed visually on a screen, and dynamically switch the search condition according to the linkage state of the search conditions.

Although the aforementioned description has illustrated a portable communication terminal as an example of the information processing device 100, devices to which the present disclosure can be applied are not limited thereto. It is needless to mention that the present disclosure is similarly applicable to personal computers, television receivers, stationary or portable game machines, music players, and the like. In addition, although the aforementioned description has illustrated an example in which the display section 110 of the information processing device 100 has a touch panel 112, the present disclosure is not limited thereto. It is needless to mention that a device without a touch panel, for example, can also visually display search conditions based on an operation of a user, and can similarly switch the search condition in accordance with the display state of the search conditions.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

The present disclosure contains subject matter related to that disclosed in Japanese Priority Patent Application JP 2010-168337 filed in the Japan Patent Office on Jul. 27, 2010, the entire content of which is hereby incorporated by reference.

What is claimed is:

1. An information processing device comprising:
a search condition display controller configured to visually display search conditions that are adapted to be linked together based on an operation of a user, and to control display positions of the search conditions in response to an operation of the user; and
a search processing section configured to change a logical expression of the search conditions in accordance with display states of the search conditions displayed by the search condition display controller, and to execute a search.

2. The information processing device according to claim 1, wherein the search processing section, when the search conditions displayed by the search condition display controller are linked together, executes an AND search using the search conditions, and when the search conditions displayed by the search condition display controller are not linked together, executes an OR search using the search conditions.

3. The information processing device according to claim 1, wherein the search conditions visually displayed by the search condition display controller are circular in shape.

4. The information processing device according to claim 1, wherein the search condition display controller, when the search conditions visually displayed by the search condition display controller have come into contact with one another, displays the search conditions by integrating the search conditions.

5. The information processing device according to claim 1, wherein when a second search condition displayed by the search condition display controller has been moved and located in proximity to a first search condition visually displayed by the search condition display controller for a period longer than or equal to a given period, the search condition display controller displays the second search condition inside the first search condition, and the search processing section executes an AND search using the first search condition and the second search condition.

6. The information processing device according to claim 5, wherein when, in a state in which the second search condition is displayed inside the first search condition, a third search condition displayed by the search condition display controller has been moved and located in proximity to the first search condition for a period longer than or equal to a given period, the search condition display controller displays the second search condition and the third search condition inside the first search condition, and the search processing section changes the logical expression of the search conditions in accordance with a linkage state of the second search condition and the third search condition, and executes a search.

7. The information processing device according to claim 1, wherein when a second search condition displayed by the search condition display controller has been moved and located in proximity to a first search condition visually displayed by the search condition display controller, the search condition display controller controls an easiness for the first search condition and the second search condition to be linked together based on a result of an AND search executed using the first search condition and the second search condition.

8. The information processing device according to claim 7, wherein the search condition display controller, if the AND search executed using the first search condition and the second search condition has no matching result, performs control such that the first search condition and the second search condition are not linked together.

9. The information processing device according to claim 1, wherein when a predesignated search condition is specified, the search condition display controller visually displays the specified search condition.

10. The information processing device according to claim 1, wherein the search processing section executes a search process in accordance with the display positions of the search conditions displayed by the search condition display controller.

11. An information display method comprising:
controlling a search condition display by visually displaying search conditions that are adapted to be linked together based on an operation of a user and by controlling display positions of the search conditions in response to an operation of the user; and
processing a search by changing a logical expression of the search conditions in accordance with display states of the search conditions and by executing a search.

12. A computer program for causing a computer to execute:
controlling a search condition display by visually displaying search conditions that are adapted to be linked together based on an operation of a user and by controlling display positions of the search conditions in response to an operation of the user; and
processing a search by changing a logical expression of the search conditions in accordance with display states of the search conditions and by executing a search.
